(19) United States
(12) Patent Application Publication
(10) Pub. No.: US 2008/0084641 A1
(43) Pub. Date: Apr. 10, 2008

(54) SEMICONDUCTOR INTEGRATED CIRCUIT

(75) Inventor: Atsushi NAGAYAMA, Minato-ku (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., TOKYO (JP)

(21) Appl. No.: 11/769,124

(22) Filed: Jun. 27, 2007

(30) Foreign Application Priority Data
Oct. 5, 2006 (JP) 2006-273579

(51) Int. Cl. H02H 9/04; H02H 3/22

(52) U.S. Cl. 361/56; 361/111

(57) ABSTRACT

The present invention provides a semiconductor integrated circuit that enhances resistance to an electrostatic discharge (ESD) as needed without re-fabricating masks. In the semiconductor integrated circuit, protection cells are formed within a core circuit. According to the degree of necessity of the ESD resistance, a wiring for connecting each of the protection cells and an output terminal of an ESD trigger detection circuit is formed in a wiring layer.

### BACKGROUND OF THE INVENTION

The present invention relates to a technique for improving resistance to an electrostatic discharge (ESD) in a semiconductor integrated circuit.

In general, a semiconductor integrated circuit is provided with an ESD protection circuit to protect a functional circuit for realizing a specific function from an electrostatic surge applied through an input/output terminal. In a semiconductor integrated circuit disclosed in, for example, a patent document 1 (Japanese Unexamined Patent Publication No. 2000-236065), an ESD protection circuit including protective elements (transistors) for causing a surge current to flow is formed outside a functional circuit. Such an ESD protection circuit is designed so as to induce the surge current between a power terminal and a ground terminal and limit a voltage applied to the functional circuit outside of the functional circuit.

In the conventional semiconductor integrated circuit provided with the ESD protection circuit, however, there is a case where since the impedance that a surge current path between the power terminal and the ground terminal has is large in practice, the voltage applied to the functional circuit becomes higher than a breakdown voltage of the functional circuit, thereby destroying the functional circuit. In such a case, for example, the transistors configured as the protective elements are re-designed. Therefore, all masks for a bedding layer in the semiconductor integrated circuit had to be re-fabricated. Accordingly, there has been a demand for a semiconductor integrated circuit capable of improving resistance to an electrostatic discharge as needed without re-fabricating the masks.

### SUMMARY OF THE INVENTION

With the foregoing in view, it is therefore an object of the present invention is to provide a semiconductor integrated circuit that enhances resistance to an electrostatic discharge (ESD) as needed without re-fabricating masks.

According to one aspect of the present invention, for attaining the above object, there is provided a semiconductor integrated circuit comprising input/output terminals, a cell-based functional circuit operated with being connected to a reference potential and one or a plurality of source potentials, an electrostatic detection unit which detects application of an electrostatic discharge to the corresponding input/output terminal, and a plurality of protection cells provided corresponding to the respective source potentials within the functional circuit and for protecting the functional circuit from the electrostatic discharge, the plurality of protection cells including transistors each connected between the reference potential and the corresponding source potential.

In the semiconductor integrated circuit of the present invention, a wiring layer for connecting the protection cells and the corresponding electrostatic detection unit and bringing the transistors of the protection cells into conduction in response to the detection of the electrostatic discharge by the electrostatic detection unit is formed.

According to the semiconductor integrated circuit of the present invention, ESD resistance can be enhanced by only a change in the design of the wiring layer. Thus, there is no need to make a design change that each mask corresponding to a bedding layer for forming a transistor having a basic ESD protecting function is re-fabricated.

According to the semiconductor integrated circuit of the present invention, resistance to an electrostatic discharge can be enhanced as needed without re-fabricating each mask.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a plan view showing a circuit configuration of an integrated circuit configured as a reference circuit;

FIG. 2 is a circuit diagram illustrating one example of an ESD trigger detection circuit;

FIG. 3A-3B is a waveform diagram for describing the operation of the ESD trigger detection circuit;

FIG. 4 is a diagram depicting the flow of an ESD surge current at the time that an ESD event occurs at an input/output terminal of the integrated circuit configured as the reference circuit;

FIG. 5 is a plan view showing a circuit configuration (protection cell validity) of an integrated circuit according to a first embodiment;

FIG. 6 is a plan view illustrating a circuit configuration (protection cell invalidity) of the integrated circuit according to the first embodiment;

FIG. 7A-7B is a circuit diagram showing one example of a protection cell;

FIG. 8A-8B is a circuit diagram depicting one example of a protection cell;

FIG. 9A-9B is a circuit diagram showing one example of a protection cell;

FIG. 10 is a diagram illustrating the flow of an ESD surge current at the time that an ESD event occurs at an input/output terminal of the integrated circuit according to the first embodiment;

FIG. 11 is a plan view showing a preferred circuit configuration of the integrated circuit according to the first embodiment;

FIG. 12 is a plan view illustrating a circuit configuration (protection cell validity) of an integrated circuit according to a second embodiment;

FIG. 13 is a plan view depicting a circuit configuration (protection cell invalidity) of the integrated circuit according to the second embodiment;

FIG. 14 is a diagram showing the flow of an ESD surge current at the time that an ESD event takes place at an input/output terminal of the integrated circuit according to the second embodiment;

FIG. 15 is a diagram illustrating the flow of an ESD surge current at the time that an ESD event occurs at an input/output terminal of the integrated circuit according to the second embodiment; and

FIG. 16 is a plan view showing a preferred circuit configuration of the integrated circuit according to the second embodiment.

### DETAILED DESCRIPTION OF THE PREFERRED EMBODIMENTS

Preferred embodiments of the present invention will hereinafter be described with reference to the accompanying drawings.

### First Preferred Embodiment

Prior to the description of a first embodiment of the present invention, a semiconductor integrated circuit (integrated circuit 2) configured as a reference circuit according to the first embodiment of the present invention will be explained for the understanding of the present invention.

### [Integrated Circuit 2 (Reference Circuit)]

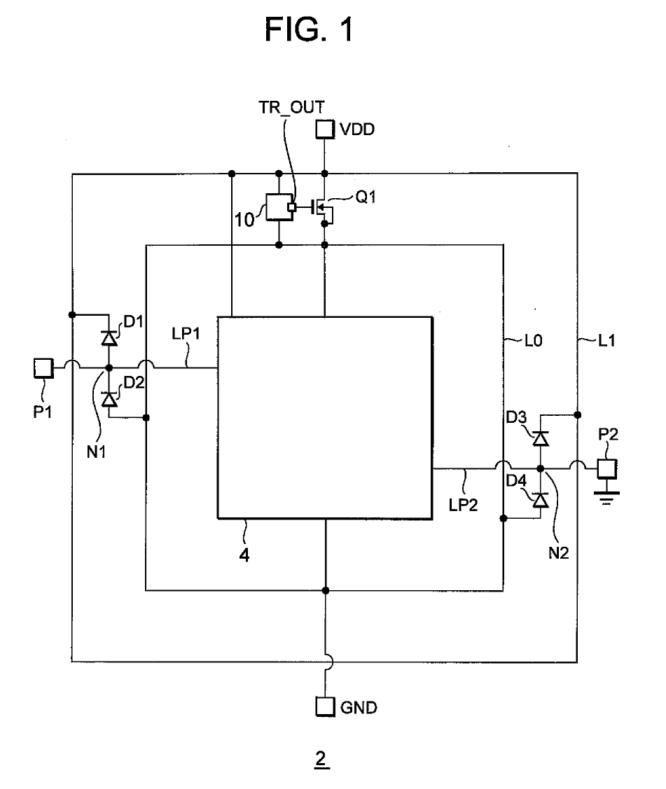

FIG. 1 is a plan view showing a circuit configuration of the integrated circuit 2. The integrated circuit 2 includes a functional circuit 4 for realizing a specific function, which is laid out in the center thereof. Input/output terminals (pads P1 and P2, a VDD terminal (source potential VDD), a GND terminal (ground potential GND) and the like), and an ESD protection circuit are provided around the functional circuit 4.

The functional circuit 4 is a cell-based integrated circuit. In general, unused cells are disposed in the cell-based integrated circuit such that logic can be changed only by wiring. Further, a cell containing a decoupling capacitor for removing noise between a power supply and ground, and the like are disposed in the cell-based integrated circuit.

The ESD protection circuit of the integrated circuit 2 will be explained below. The present ESD protection circuit includes wirings L0 and L1, diodes D1 through D4, an ESD trigger detection circuit 10 (electrostatic detection unit) and an NMOS transistor Q1. The ring-shaped wiring L0 (ground wiring) is provided around the functional circuit 4 and connected to the GND terminal. The ring-shaped wiring L1 (power wiring) is provided around the wiring L0 and connected to the VDD terminal.

The diodes D1 and D2 are connected to a node N1 lying on a wiring LP1 extending from the pad P1 to the functional circuit 4. That is, the anode of the diode D1 is connected to the node N1, and the cathode of the diode D1 is connected to the wiring L1. The anode of the diode D2 is connected to the wiring L0, and the cathode of the diode D2 is connected to the node N1.

The diodes D3 and D4 are connected to a node N2 lying on a wiring LP2 extending from the pad P2 to the functional circuit 4. That is, the anode of the diode D3 is connected to the node N2, and the cathode of the diode D3 is connected to the wiring L1. The anode of the diode D4 is connected to the wiring L0, and the cathode of the diode D4 is connected to the node N2.

The NMOS transistor Q1 is provided between the wiring L0 and the wiring L1. That is, the drain of the NMOS transistor Q1 is connected to the wiring L1 (source potential VDD) and the source thereof is connected to the wiring L0 (ground potential GND). The gate of the NMOS transistor Q1 is connected to an output terminal TR_OUT of the ESD trigger detection circuit 10. The NMOS transistor Q1 has the role of going ON when the output terminal TR_OUT of the ESD trigger detection circuit 10 is brought to a high level (H level), and leading an ESD-based surge current from the wiring L1 to the wiring L0.

The ESD trigger detection circuit 10 is provided between the wiring L1 and the wiring L0 and operated by the source potential VDD. The ESD trigger detection circuit 10 is a circuit for detecting the occurrence of an ESD event inputted via the corresponding input/output terminal.

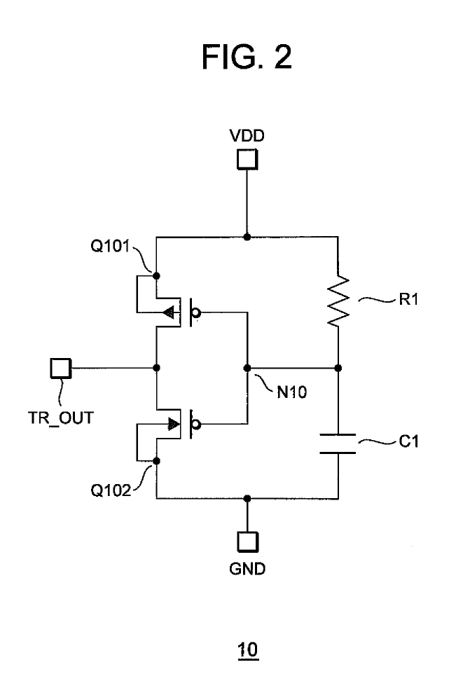

FIG. 2 is a circuit diagram showing one example of an ESD trigger detection circuit 10. A VDD terminal and a GND terminal shown in FIG. 2 are respectively connected to the wiring L1 and the wiring L0 when applied to the functional circuit 4. The ESD trigger detection circuit 10 shown in FIG. 2 has a resistor R1 and a capacitor C1 connected in series between the VDD terminal and the GND terminal, and a PMOS transistor Q101 and an NMOS transistor Q102 that constitute an inverter. A node N10 provided at one end (positive polarity side) of the capacitor C1 functions as an input to the inverter. An output of the inverter functions as an output terminal TR_OUT of the ESD trigger detection circuit 10.

While the resistor R1 and the capacitor C1 constitute a low-pass filter (LPF) in the ESD trigger detection circuit 10, the time-constant (C1×R1) of the LPF is set to such a large value as not to be affected by a steep rise in voltage applied to the VDD terminal with the occurrence of ESD.

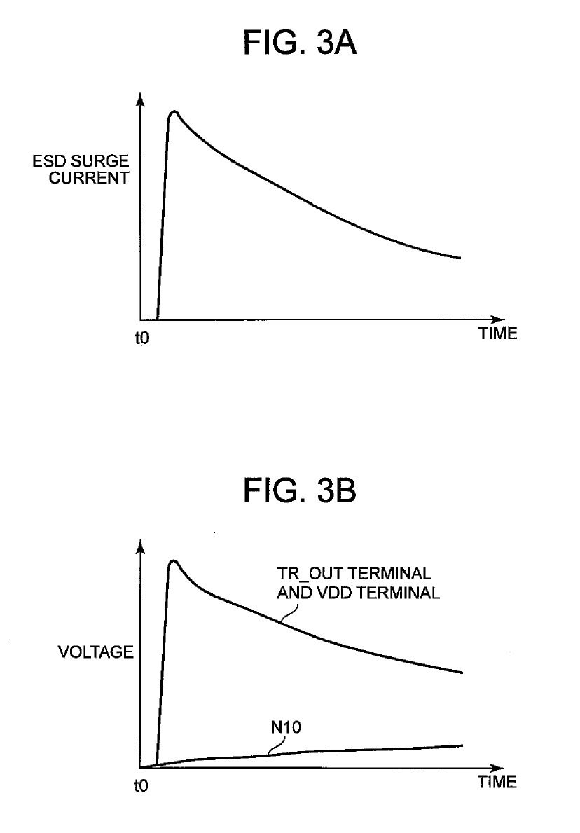

The operation of the ESD trigger detection circuit 10 will be explained with reference to FIG. 3A-3B. FIG. 3A shows an ESD surge current waveform and FIG. 3B shows voltage waveforms of respective parts. The ESD surge current waveform shown in FIG. 3A is a waveform defined to an HBM (Human Body Model) test corresponding to a public test method. In FIG. 3A-3B, the time at which an ESD event has occurred is defined as t0.

When the ESD event occurs and the ESD surge current shown in FIG. 3A occurs in the wiring L1 of the functional circuit 4, the voltage at the VDD terminal in FIG. 2 also steeply rises from the time to in like manner as shown in FIG. 3B. On the other hand, since the time constant of the LPF constituted of the resistor R1 and the capacitor C1 is large, the voltage at the node N10 does not follow a steep change in voltage at the VDD terminal and rises gently as shown in FIG. 3B. As a result, after the occurrence of the ESD event, an inverter input of the ESD trigger detection circuit 10 is maintained at a low level (L level), and the voltage at the output terminal TR_OUT, corresponding to its inverter output is maintained at an H level. That is, the voltage of the output terminal TR_OUT becomes approximately equal to the level of the voltage at the VDD terminal as shown in FIG. 3B.

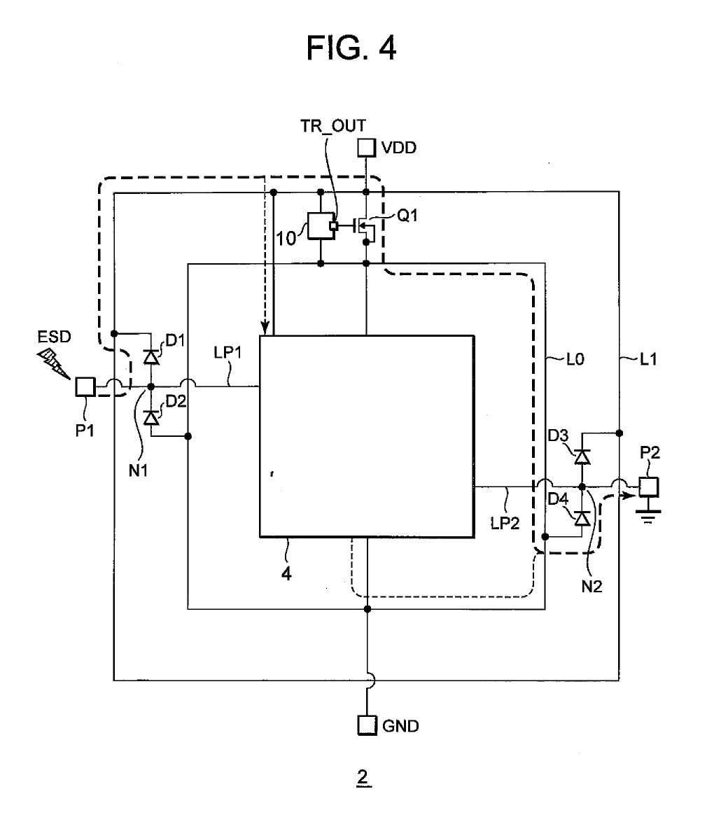

An ESD protecting operation of the integrated circuit 2 will next be explained with reference to FIG. 4. FIG. 4 is a diagram showing the flow of an ESD surge current at the time that an ESD event occurs at the input/output terminal of the integrated circuit 2. Incidentally, FIG. 4 assumes the case where the ESD event occurs at the pad P1.

When the ESD event occurs at the pad P1 as shown in FIG. 47 the ESD surge current that flows from the pad P1 flows through the diode D1 in the forward direction via the node N1 and thereafter flows through the wiring L1. When the output terminal TR_OUT of the ESD trigger detection circuit 10 goes a H level with a rise in voltage at the wiring L1, the NMOS transistor Q1 is turned ON, so that the wiring L1 and the wiring L0 are short-circuited. Thus, the surge current that flows through the wiring L1 is led to the wiring L0 and flows into the grounded pad P2 via the diode D4 and node N2 connected in the forward direction. Incidentally, although the current is consumed or used up even within the functional circuit 4 upon the occurrence of the ESD event, it is very smaller than the surge current that flows through the NMOS transistor Q1.

When the ESD event occurs at the pad P1 as mentioned above, the majority of the ESD surge current flows through the wirings L0 and L1 provided around the functional circuit 4 as shown in FIG. 4. While the ESD surge current is flowing, it is such designed that the voltage applied to the functional circuit 4 does not reach a breakdown voltage of the functional circuit 4.

Incidentally, there is a case where when the integrated circuit 2 is manufactured and an ESD test is actually effected thereon, the voltage applied to the functional circuit 4 exceeds the breakdown voltage due to the fact that the impedance at the current path of the surge current shown in FIG. 4 is high, so that the functional circuit 4 leads to a breakdown. The ESD test is normally conducted on the completed integrated circuit 2. When, however, it is revealed that ESD resistance of the completed integrated circuit 2 is low, there is a need to change the design of the NMOS transistor Q1 and the diodes. Therefore, all masks for each bedding layer of the integrated circuit 2 must be re-fabricated.

### Configuration of Integrated Circuit 1 (First Embodiment)

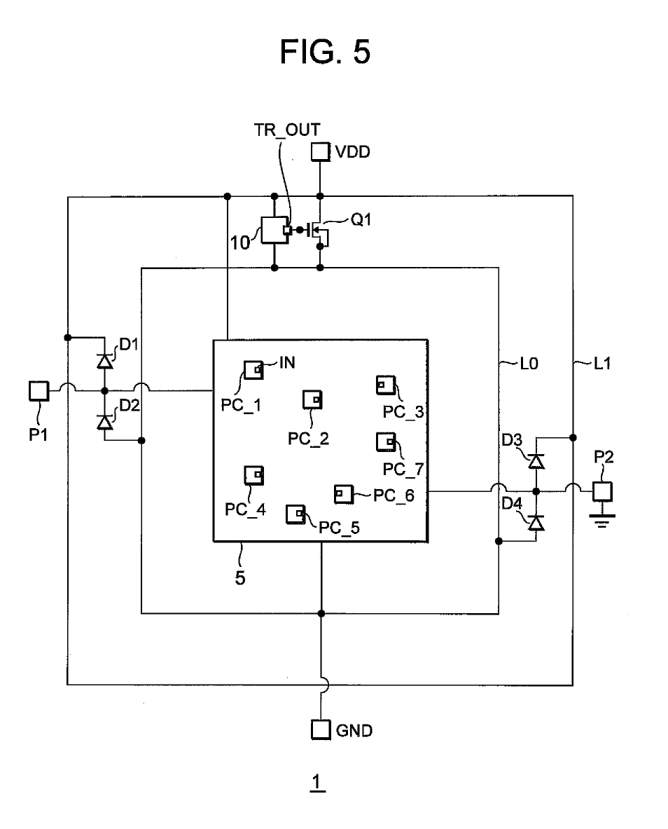

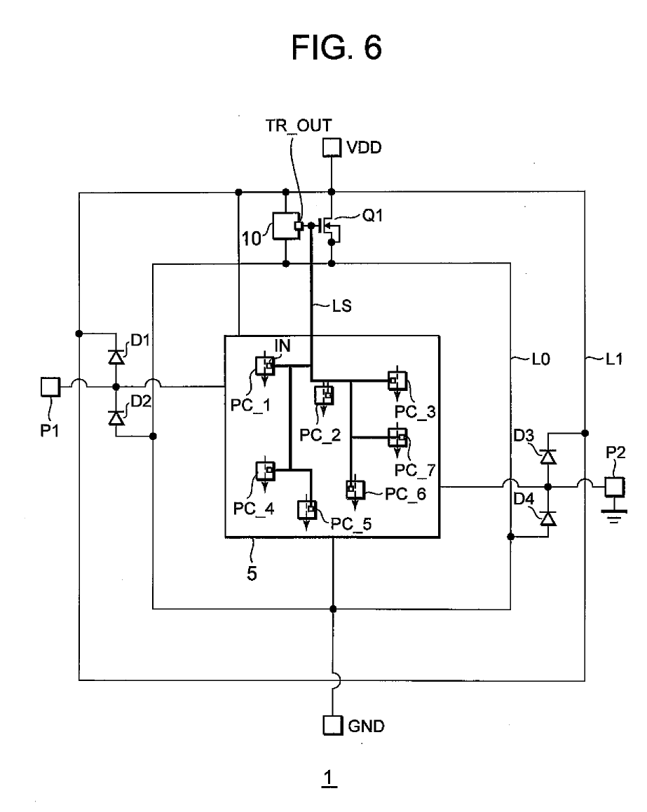

The configuration of the integrated circuit 1 according to the first embodiment will next be explained with reference to FIGS. 5 and 6.

The semiconductor integrated circuit according to the first embodiment of the present invention to be described below is different from the integrated circuit 2 (reference circuit) referred to above. Even when it is found after the semiconductor integrated circuit is completed once that ESD resistance is low, there is no need to re-fabricate the masks for the bedding layers, and the ESD resistance can be enhanced by a small change in design. Described specifically, the semiconductor integrated circuit according to the first embodiment is capable of enhancing ESD resistance by changing only an upper metal wiring layer without changing the mask for each bedding layer.

FIGS. 5 and 6 are respectively plan views showing a circuit configuration of the integrated circuit 1 according to the present embodiment. However, the same symbols are attached to the same portions or components as those in the integrated circuit 2 shown in FIG. 1, and their dual explanations will be omitted. Incidentally, FIG. 5 shows the case in which protection cells PCs (to be described later) are made invalid, and FIG. 6 shows the case in which the protection cells PCs are made valid.

The integrated circuit I of the present embodiment is different from the integrated circuit 2 in that protection cells PCs for protecting a functional circuit from an ESD event are provided at part of a cell group lying inside the functional circuit. In the integrated circuit 1 shown in FIG. 5, seven protection cells PC_1 through PC_7 are formed within the functional circuit 5. These protection cells PCs are fabricated in advance using a free cell space or area lying within the functional circuit 5.

As shown in FIG. 6, the respective protection cells PCs and an output terminal TR_OUT of an ESD trigger detection circuit 10 are connectable as needed by providing a wiring LS at the metal wiring layer of the integrated circuit 1. Thus, the protective cells PCs can be rendered valid. That is, when it is revealed after the integrated circuit 1 has been completed in a state free of the connection of the wiring LS that sufficient ESD resistance can be ensured by only an ESD protection circuit (having the same protecting function as in the above integrated circuit 2) of the integrated circuit, the protection cells PCs and the output terminal TR_OUT of the ESD trigger detection circuit 10 are not connected. On the other hand, when it is found after the integrated circuit 1 has been completed in the state free of the connection of the wiring LS that sufficient ESD resistance is not ensured by only the ESD protection circuit of the integrated circuit, the protection cells PCs and the output terminal TR_OUT of the ESD trigger detection circuit 10 are connected by the wiring LS to bring each protection cell PC to an operable state.

When an ESD event occurs, the protection cells PCs are designed in such a manner that a surge current flowing through the a wiring L1 can be drawn into a GND terminal.

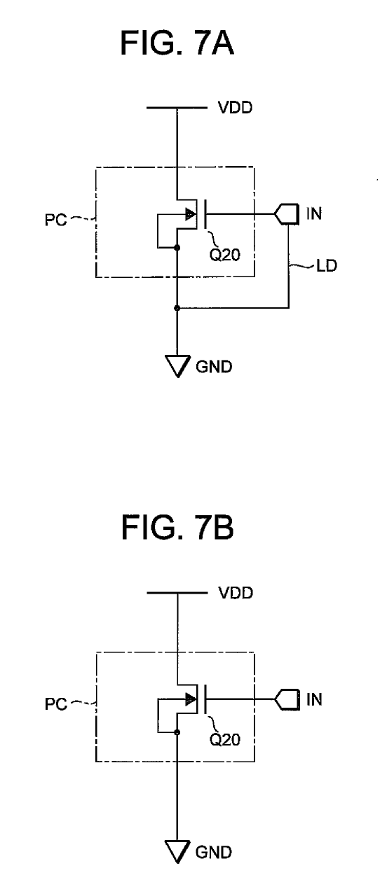

Several circuit configuration examples of the protection cells PC will be explained with reference to FIGS. 7 through 9. FIGS. 7 through 9 are respectively circuit diagrams one examples of the protection cells PCs, wherein FIGS. 7(a) through 9(a) are diagrams including wirings at the time that the protection cells PCs are made invalid, and FIGS. 7(b) through 9(b) are diagrams including wirings at the time that the protection cells PCs are made valid, respectively.

In the integrate circuit 1, the protection cells PCs are formed in the free cell space or area of the functional circuit 5 in advance in states of such wirings as shown in FIGS. 7(a) through 9(a). When it is found that an ESD test is done in such wired states and sufficient ESD resistance is not ensured from its result, the wiring layer of the integrated circuit 1 is changed in design so as to bring about such wired states as shown in FIGS. 7(b) through 9(b). That is, the wirings LD (corresponding to wirings for connecting input terminals IN and GND terminals for the protective cells PCs) shown in FIGS. 7(a) through 9(a) are removed upon the change in the design of the wiring layer, and the wiring LS (see FIG. 6) provided between the output terminal TR_OUT of the ESD trigger detection circuit 10 and the input terminals IN of the protection cells PCs are provided.

In such states as shown in FIGS. 7(a) through 9(a), the input terminals IN of the protection cells PCs are always brought to the ground potential, and the protection cells PCs do not function.

Where the protection cells PCs function, that is, the wiring LS is provided between the output terminal TR_OUT of the ESD trigger detection circuit 10 and the input terminal IN of each of the protection cells PCs, and the wirings for the respective protection cells PCs are set as shown in FIGS. 7(b) through 9(b), the configurations and operations of the protection cells PCs will be explained sequentially.

Each of the protection cells PC illustrated in FIG. 7A-7B is constituted of only a single NMOS transistor Q20. The drain of the NMOS transistor Q20 is connected to a VDD terminal. That is, it is equivalent to the fact that the drain of the NMOS transistor Q20 is connected to the wiring L1 provided around the functional circuit 5. The source of the NMOS transistor Q20 is connected to the GND terminal. The gate of the NMOS transistor Q20 is connected to the output terminal TR_OT of the ESD trigger detection circuit 10 via the input terminal IN. Thus, when an ESD event is detected by the ESD trigger detection circuit 10 and the output terminal TR_OUT thereof is brought to an H level, the NMOS transistor Q20 lying within each protection cell PC is turned ON so that a surge current flowing through the wiring L1 is drawn into the GND terminal.

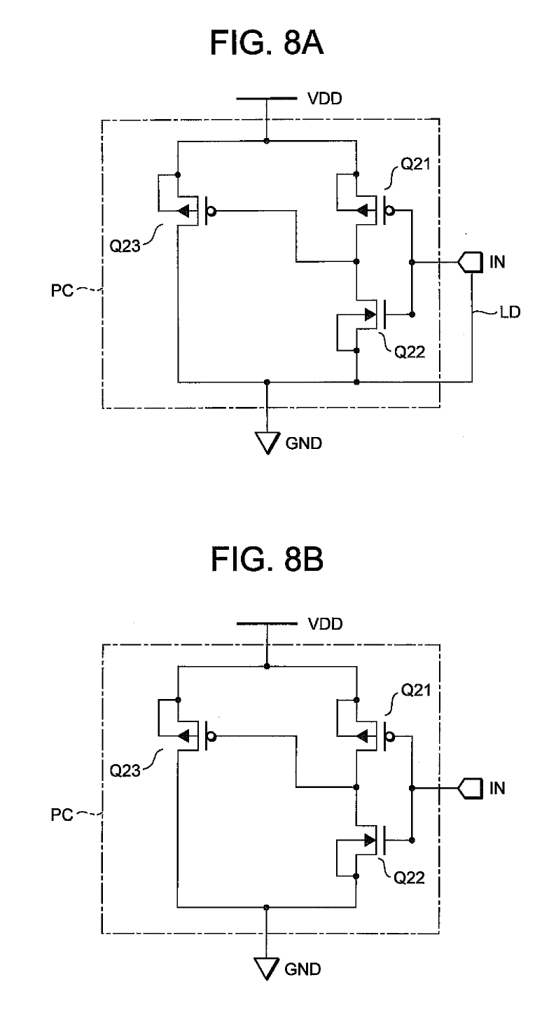

Each of the protection cells PCs illustrated in FIG. 8A-8B has a PMOS transistor Q21 and an NMOS transistor Q22 that constitute an inverter, and a PMOS transistor Q23. An input terminal IN is connected to the input of the inverter, and the output of the inverter is connected to the gate of the PMOS transistor Q23. The source of the PMOS transistor Q23 is connected to a VDD terminal. That is, this is equivalent to the fact that the source of the NMOS transistor Q20 is connected to the wiring L1 provided around the functional circuit 5. The drain of the PMOS transistor Q23 is connected to a GND terminal. An inverter input of the protection cell PC is connected to its corresponding output terminal TR_OUT of the ESD trigger detection circuit 10 via the input terminal IN. Thus, when an ESD event is detected by the ESD trigger detection circuit 10 and the output terminal TR_OUT thereof is rendered H in level, the output of the inverter is brought to an L level, so that the PMOS transistor Q23 is turned ON to draw a surge current flowing through the wiring L1 into the GND terminal.

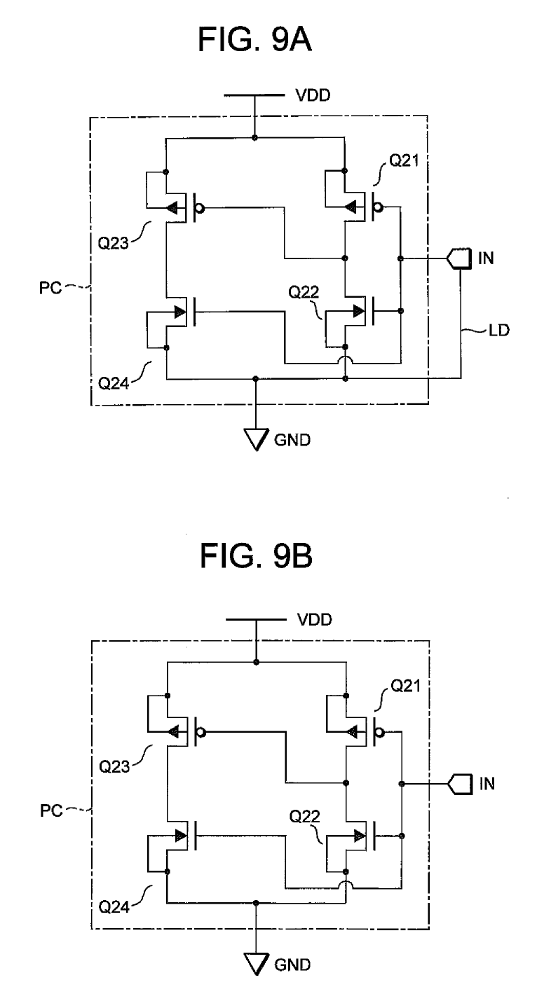

As compared with each protection cell PC shown in FIG. 8A-8B, each of the protection cells PCs illustrated in FIG. 9A-9B is different from that shown in FIG. 8A-8B only in that an NMOS transistor Q24 is added thereto. The drain of the NMOS transistor Q24 is connected to its corresponding drain of a PMOS transistor Q23. The source of the NMOS transistor Q24 is connected to the GND terminal. The gate of the NMOS transistor Q24 is connected to its corresponding input terminal IN of the protection cell PC. When the output terminal TR_OUT of the ESD trigger detection circuit 10 is of an H level, the PMOS transistor Q23 and the NMOS transistor Q24 are both turned ON in the protection cell PC so that a surge current flowing through the wiring L1 is drawn into the GND terminal.

Incidentally, although each of the inverters is provided at the input part in each of the protection cells PCs illustrated in FIGS. 8 and 9, it may be a gate circuit (logic circuit) capable of inverting a logical level (i.e., a logical level of the output terminal TR_OUT of the ESD trigger detection circuit 10) of the input terminal IN. It can also be formed by, for example, an NAND circuit or a NOR circuit.

Each of the circuits for the protection cells PCs shown in FIG. 7A-7B is constituted of only the NMOS transistor large in current drive capacity. Most preferred may be one where the current drive capacity and the exclusively-possessed area of each cell are taken into consideration.

### [Operation of Integrated Circuit 1]

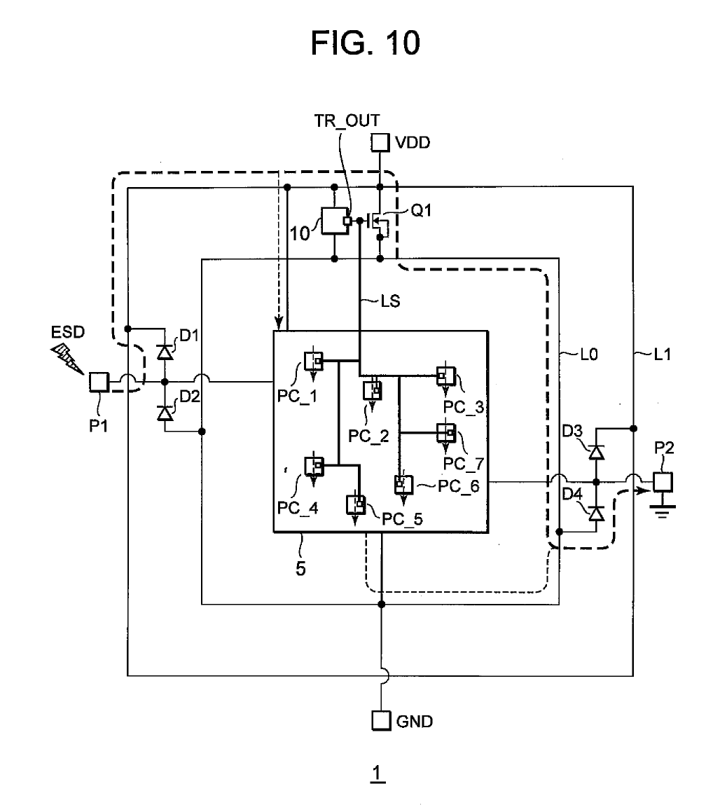

An ESD protecting operation of the integrated circuit 1 at the time that each protection cell PC lying within the functional circuit 5 is made valid will next be explained with reference to FIG. 10.

FIG. 10 is a diagram showing the flow of an ESD surge current at the time that an ESD event occurs at the input/output terminal of the integrated circuit 1. Incidentally, FIG. 10 assumes the case where the ESD event occurs at the pad PI.

When the ESD event occurs at the pad PI as shown in FIG. 10, the ESD surge current that flows from the pad P1 flows through the diode D1 in the forward direction via the node N1 and thereafter flows through the wiring L1. When the output terminal TR_OUT of the ESD trigger detection circuit 10 goes a H level with a rise in voltage at the wiring L1, the NMOS transistor Q1 is turned ON, so that the wiring L1 and the wiring L0 are short-circuited. Thus, the surge current that flows through the wiring L1 is led to the wiring L0 and flows into the grounded pad P2 via the diode D4 and node N2 connected in the forward direction.

On the other hand, when the output terminal TR_OUT of the ESD trigger detection circuit 10 is brought to the H level, transistors (equivalent to NMOS transistors Q20 in the protection cells PCs illustrated in FIG. 7A-7B by way of example) respectively provided between the VDD terminals and GND terminals lying within the respective protection cells PC_1 through PC_7 provided in the functional circuit 5 are turned ON, so that some of the surge current flowing through the wiring L1 flows from the respective protection cells to the GND terminal via the wiring LS.

Thus, in the integrated circuit 1 at the time that the protection cells PCs lying within the functional circuit 5 are made valid, the ESD surge current that flows from the pad P1 is dispersed not only into current paths provided around the functional circuit 5 but also into a plurality of current paths via the protection cells PCs provided inside the functional circuit 5, followed by being discharged to the GND terminal. Therefore, ESD resistance of the functional circuit 5 is enhanced as compared with the case in which each protection cell PC is made invalid (no wiring LS is wire-connected).

According to the integrated circuit 1 of the present embodiment as described above, the protection cells PCs are built into the free cell space or area lying within the functional circuit 5 in advance. The ESD resistance of the integrated circuit can be enhanced by only the change in the design of the wiring layer as needed. Thus, even when the ESD test is conducted on the integrated circuit completed once and it is found from the result thereof that the ESD resistance of the completed integrated circuit is low, there is no need to carry out the change of design that masks for each bedding layer of the integrated circuit are re-fabricated.

Incidentally, although the ESD protection circuit including the ESD trigger detection circuit 10 and also including the NMOS transistor Q1 is provided outside the functional circuit 5 in the integrated circuit 1 of the present embodiment, the present invention is not limited to it. The ESD protection circuit may be provided inside the functional circuit 5.

In the integrated circuit 1 of the present embodiment, the ESD protection circuit provided outside the functional circuit 5 is no more than one example, and other ESD protection circuits can also be applied thereto. That is, the ESD protection circuit provided outside the functional circuit 5 is nothing more than one example for realizing a circuit provided with a basic ESD protecting function. The gist of the present invention resides in that the changing of the above integrated circuit to an integrated circuit provided with an ESD protecting function further enhanced from the basic ESD protecting function by a change in wiring layer alone can be made with relative ease.

Thus, the input terminal IN of one protective cell in the protection cells PC_1 through PC_7 shown in FIG. 5 and the output terminal TR_OUT of the ESD trigger detection circuit 10 are wire-connected in advance, and the input terminals IN of the remaining protection cells are wire-connected to the output terminal TR_OUT depending upon the result of evaluation by the ESD test, whereby the ESD resistance may be enhanced. Such a configuration makes it unnecessary to provide the NMOS transistor Q1 shown in FIG. 5.

### [Modifications]

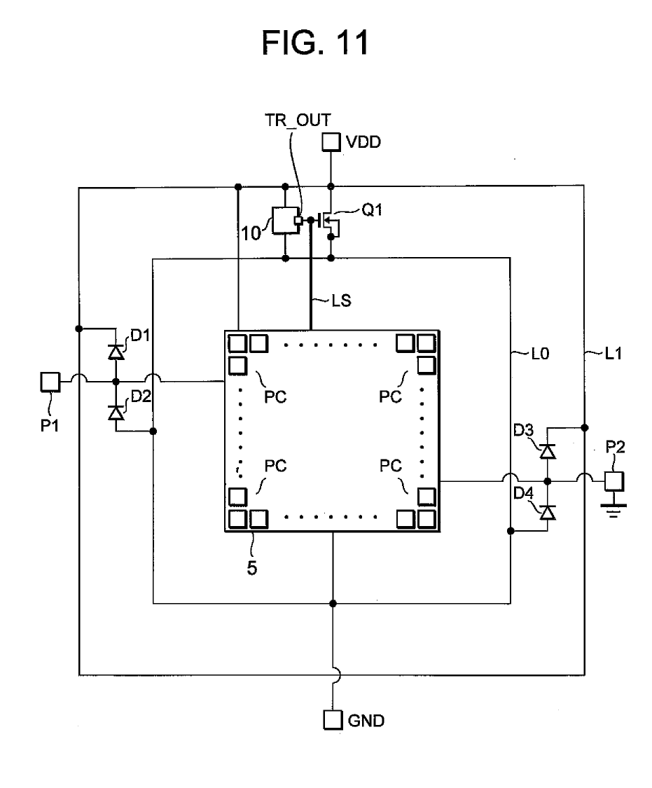

Preferred layouts of the protection cells PCs employed in the integrated circuit according to the present embodiment will be explained below with reference to FIG. 11. FIG. 11 is a plan view showing a preferred circuit configuration of the integrated circuit according to the first embodiment.

In the integrated circuit shown in FIG. 11, areas (protection cell areas) in which the protection cells PCs lying within the functional circuit 5 are formed, are disposed at their corresponding ends of an area (core area) of the functional circuit 5. Although an area (electrostatic detection area) containing the ESD trigger detection circuit 10 is formed outside the core area, it may be formed inside the core area.

Laying out the respective protection cells PCs at the ends of the area of the functional circuit 5 in this way makes it possible to bring the sum of current paths between the VDD terminal and the GND terminal to the minimum. Thus, since the impedance of a path along which a surge current at the occurrence of an ESD event flows can be reduced as small as possible, ESD resistance of the integrated circuit can further be enhanced as compared with the case in which the protection cells are disposed within the core area at random.

### Second Preferred Embodiment

A second embodiment showing a semiconductor integrated circuit according to the present invention will next be explained. The semiconductor integrated circuit (integrated circuit 3 to be described later) according to the second embodiment differs from the integrated circuit 1 of the first embodiment in that the inside of a functional circuit is operated by two power supplies. The semiconductor integrated circuit operated by the two power supplies has been becoming a relatively general configuration in recent years. For example, it has been practiced to design such a semiconductor integrated circuit that an input/output unit which interfaces with an external device, is operated at a source voltage of 3.3V, and other internal circuits are operated at a source voltage of 1.2V.

### Configuration of Integrated Circuit 3 (Second Embodiment)

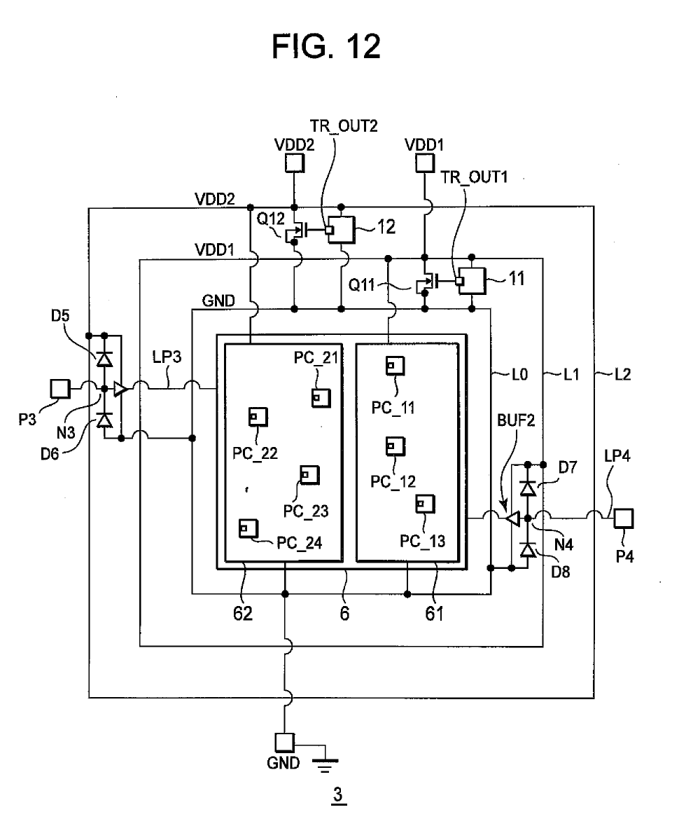

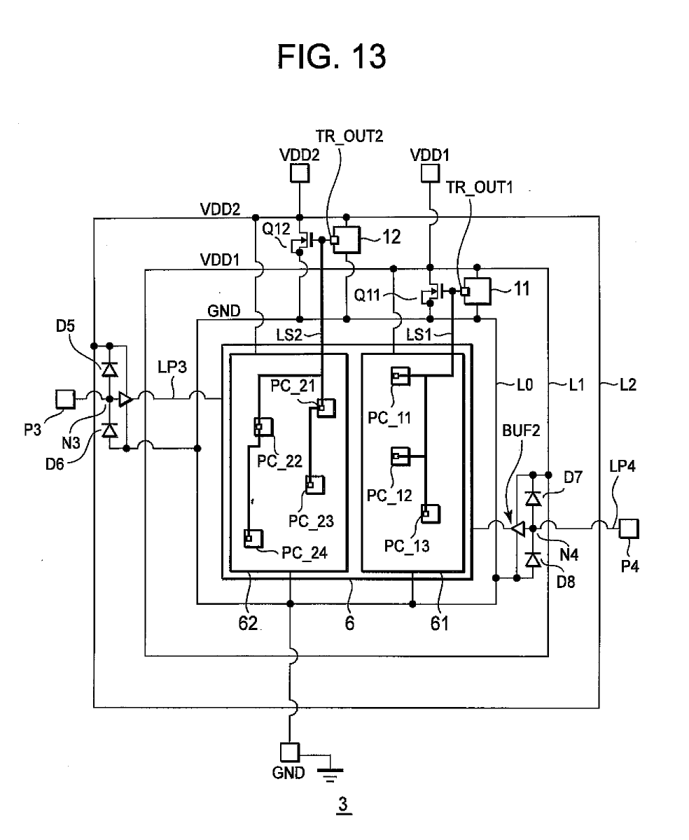

The configuration of the integrated circuit 3 according to the second embodiment will be explained below with reference to FIGS. 12 and 13. The integrated circuit 3 is operated at two power supplies corresponding to a first source potential VDD1 and a second source potential VDD2.

FIGS. 12 and 13 are respectively plan views showing a circuit configuration of the integrated circuit 3 according to the present embodiment. Incidentally, FIG. 12 shows the case in which protection cells PCs are made invalid, and FIG. 13 shows the case in which the protection cells PCs are made valid.

The integrated circuit 3 shown in FIG. 12 includes a functional circuit 6 for realizing a specific function, which is laid out in the center thereof. Input/output terminals (pads P3 and P4, a VDD1 terminal (source potential VDD1), a VDD2 terminal (source potential VDD2), a GND terminal (ground potential GND) and the like), and an ESD protection circuit are provided around the functional circuit 6. The functional circuit 6 is of a cell-based integrated circuit.

The ESD protection circuit of the integrated circuit 3 will be explained below. The present ESD protection circuit includes wirings L0, L1 and L2, diodes D5 through D8, ESD trigger detection circuits 10 and 11 (electrostatic detection units) and NMOS transistors Q11 and Q12.

The ring-shaped wiring L0 (ground wiring) is provided around the functional circuit 6 and connected to the GND terminal. The ring-shaped wiring L1 (power wiring) is provided around the wiring L0 and connected to the VDD1 terminal. The ring-shaped wiring L2 (power wiring) is provided around the wiring L1 and connected to the VDD2 terminal. That is, the wirings L1 and L2 are provided around the wiring L0 so as to be connected to the two source potentials VDD1 and VDD2 in association with the two source potentials VDD1 and VDD2 in order toward the outside of an area (core area) formed with the functional circuit 6.

A buffer BUF1 is provided on a wiring LP3 extending from a pad P3 to the functional circuit 6. The diodes D5 and D6 are connected to a node N3 lying on the wiring LP3. That is, the anode of the diode D5 is connected to the node N3, and the cathode of the diode D5 is connected to the wiring L2. The anode of the diode D6 is connected to the wiring L0, and the cathode of the diode D6 is connected to the node N3.

A buffer BUF2 is provided on a wiring LP4 extending from the pad P4 to the functional circuit 6. The diodes D7 and D8 are connected to a node N4 provided on the wiring LP4. That is, the anode of the diode D7 is connected to the node N4, and the cathode of the diode D7 is connected to the wiring L1. The anode of the diode D8 is connected to the wiring L0, and the cathode of the diode D8 is connected to the node N4.

The ESD trigger detection circuit 11 is provided between the wiring L1 and the wiring L0 and operated by the source potential VDD1. The ESD trigger detection circuit 12 is provided between the wiring L2 and the wiring L0 and operated by the source potential VDD2. Each of the ESD trigger detection circuits 11 and 12 is a circuit for detecting the occurrence of an ESD event inputted via the corresponding input/output terminal. Incidentally, each ESD trigger detection circuit can be constituted of a circuit similar to the ESD trigger detection circuit 10 shown in FIG. 2.

The NMOS transistor Q11 is provided between the wiring L0 and the wiring L1. That is, the drain of the NMOS transistor Q11 is connected to the wiring L1 (source potential VDD1), and the source thereof is connected to the wiring L0 (ground potential GND). The gate of the NMOS transistor Q11 is connected to its corresponding output terminal TR_OUT1 of the ESD trigger detection circuit 11. The NMOS transistor Q11 has the role of going ON when the output terminal TR_OUT1 of the ESD trigger detection circuit 11 is brought to a high level (H level), and leading an ESD-based surge current from the wiring L1 to the wiring L0.

The NMOS transistor Q12 is provided between the wiring L0 and the wiring L2. That is, the drain of the NMOS transistor Q12 is connected to the wiring L2 (source potential VDD2), and the source thereof is connected to the wiring L0 (ground potential GND). The gate of the NMOS transistor Q12 is connected to its corresponding output terminal TR_OUT2 of the ESD trigger detection circuit 12. The NMOS transistor Q12 has the role of going ON when the output terminal TR_OUT2 of the ESD trigger detection circuit 12 is brought to a high level (H level), and leading an ESD-based surge current from the wiring L2 to the wiring L0.

In the integrated circuit 3 shown in FIG. 12, three protection cells PC_11 through PC_13 are disposed in a first sub area 61 lying in the functional circuit 6, and four protection cells PC_21 through PC_24 are disposed in a second sub area 62 lying in the functional circuit 56. Incidentally, the first sub area 61 is an area placed within the functional circuit 6, in which cells operated at the source potential VDD1 are formed. The second sub area 62 is an area placed within the functional circuit 6, in which cells operated at the source potential VDD2 are formed. The protection cells are fabricated in advance using free cell space defined in the respective sub areas.

Incidentally, the protection cells PC_11 through PC_13 can respectively be realized by configuring circuits similar to those for the protection cells shown in FIGS. 7 through 9 in such a manner that they are operated at the source potential VDD1. The protection cells PC_21 through PC_24 can respectively be materialized by configuring the circuits similar to those for the protection cells shown in FIGS. 7 through 9 in such a manner that they are operated at the source potential VDD2.

In a manner similar to the first embodiment, the respective protection cells PCs and the output terminals TR_OUT1 and TR_OUT2 of the ESD trigger detection circuits 11 and 12 are respectively connectable as needed by respectively providing wirings LS1 and LS2 in metal wiring layers of the integrated circuit 3. Thus, the protection cells PCs can be validated (see FIG. 13). The protection cells PCs are configured so as to be capable of being validated or invalidated independently every two source potentials at which the integrated circuit 3 is operated, i.e., every sub area lying in the core area.

### [Operation of Integrated Circuit 3]

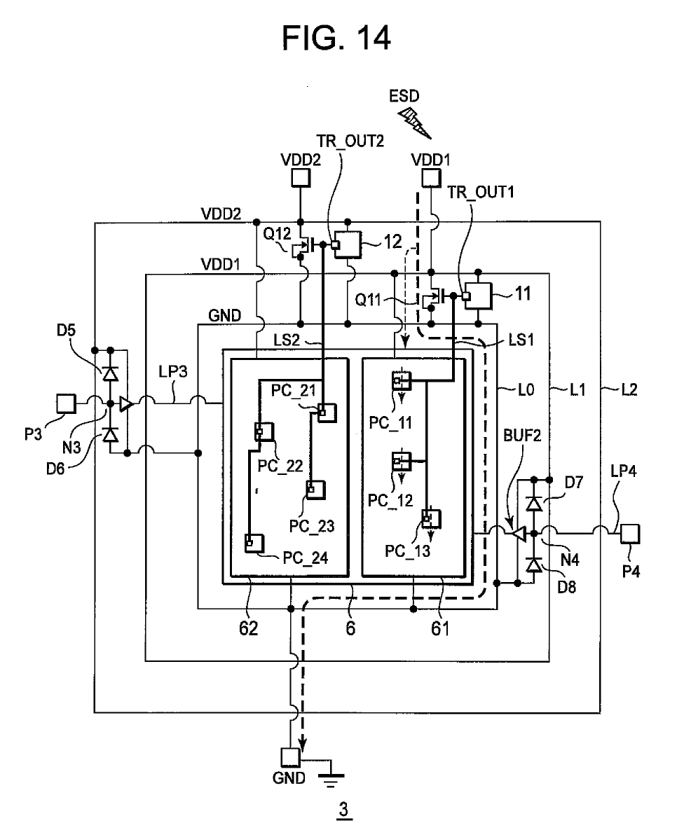

An ESD protecting operation of the integrated circuit 3 at the time that the protection cells PCs lying in the functional circuit 6 are made valid, will next be explained with reference to FIG. 14.

FIG. 14 is a diagram showing the flow of an ESD surge current at the time that an ESD event occurs at the input/output terminal of the integrated circuit 3. Incidentally, FIG. 14 assumes the case where the ESD event occurs at the VDD1 terminal.

When the ESD event occurs at the VDD1 terminal as shown in FIG. 14, the voltage at the VDD1 terminal rises and the output terminal TR_OUT1 of the ESD trigger detection circuit 11 is brought to an H level, so that the NMOS transistor Q11 is turned ON. Accordingly, the ESD surge current flows from the drain of the NMOS transistor Q11 to the source thereof, followed by flowing into the grounded GND terminal via the wiring L0.

On the other hand, when the output terminal TR_OUT1 of the ESD trigger detection circuit 11 is brought to the H level, transistors (equivalent to NMOS transistors Q20 in the protection cells PCs illustrated in FIG. 7A-7B by way of example) respectively provided within the protection cells PC_11 through PC_13 in the first subs area 61 are turned ON, so that some of the surge current flows from the respective protection cells to the GND terminal via the wiring LS1.

Thus, in the integrated circuit 3 at the time that the protection cells PCs lying within the first sub area 61 are made valid, the ESD surge current that flows from the VDD1 terminal is dispersed not only into current paths provided around the functional circuit 6 but also into a plurality of current paths via the protection cells PCs provided within the first sub area 61, followed by being discharged to the GND terminal. Therefore, ESD resistance of the functional circuit 6 is enhanced as compared with the case in which each protection cell PC is made invalid (no wiring LS1 is wire-connected).

Although a description has been made, above, of the case in which the ESD event has occurred at the VDD1 terminal, the same can be said of the VDD2 terminal. That is, in the integrated circuit 3 at the time that the protection cells PCs lying within the second sub area 62 are made valid, the ESD surge current that flows from the VDD2 terminal is dispersed not only into current paths provided around the functional circuit 6 but also into a plurality of current paths via the protection cells PC_21 through PC_24 lying within the second sub area 62, followed by being discharged to the GND terminal. Therefore, ESD resistance of the functional circuit 6 is enhanced as compared with the case in which the protection cells PCs are made invalid (no wiring LS2 is wire-connected).

Incidentally, when the ESD event occurs at each of the pads P3 and P4 in the integrated circuit 3, the external surge current path of the functional circuit 6 is similar to one described in the first embodiment.

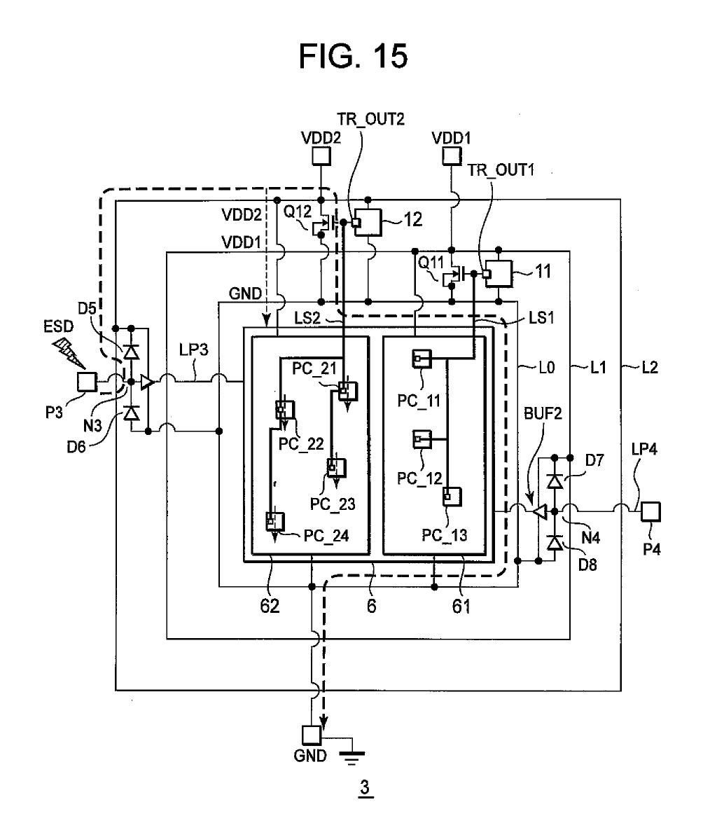

When, for example, an ESD event occurs at the pad P3, a surge current flows such as shown in FIG. 15. That is, the ESD surge current that flows from the pad P3 flows through the diode D5 in the forward direction via a node N3 and a buffer and thereafter flows through a wiring L2. When the output terminal TR_OUT2 of the ESD trigger detection circuit 12 goes an H level with a rise in voltage at the wiring L2, the NMOS transistor Q12 is turned ON, so that the wiring L2 and the wiring L0 are short-circuited. Thus, the surge current that flows through the wiring L2 is led to the wiring L0 and flows into the GND terminal via the diode D8 and node N4 connected in the forward direction. At this time, the surge current is dispersed into a plurality of current paths via the protection cells PV_21 through PC_24 lying within the second sub area 62, and discharged to the GND terminal.

In the integrated circuit 3 of the present embodiment as described above, the functional circuit 6 is operated by the two power supplies, and the protection cells PCs are built in advance in the respective free cell spaces or areas of the areas (first sub area 61 and second sub area 62) operated by the different source potentials in the function circuit 6. Accordingly, the ESD resistance of the integrated circuit can be enhanced by only the change in design of each wiring layer as needed in a manner similar to the first embodiment. Thus, even when the ESD test is conducted on the integrated circuit completed once and it is found from its test that the ESD resistance of the completed integrated circuit is low, there is no need to perform the design change that each mask for a bedding layer of the integrated circuit is re-fabricated.

### Modifications

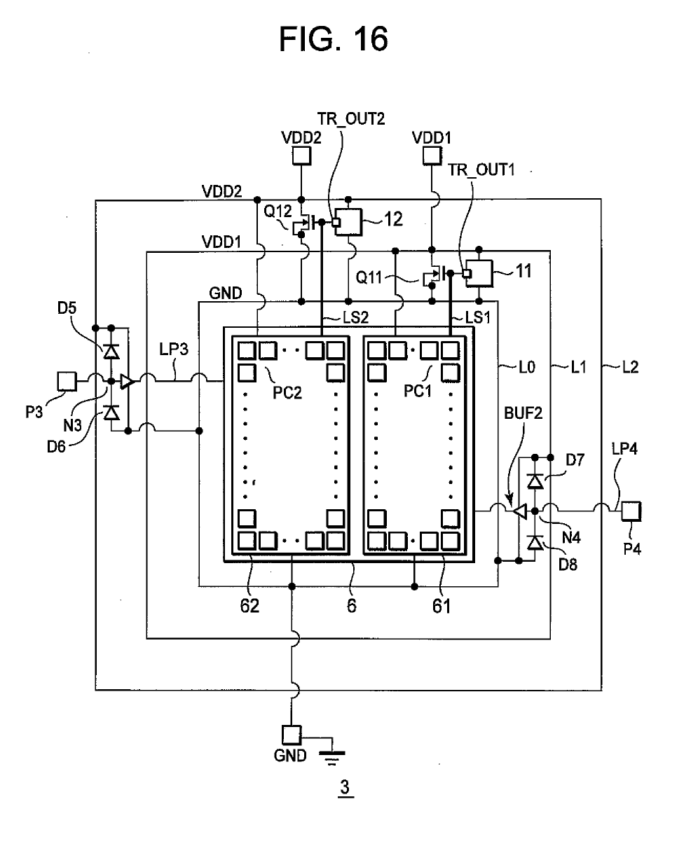

Preferred layouts of the protection cells PCs employed in the integrated circuit according to the present embodiment will be explained below with reference to FIG. 16. FIG. 16 is a plan view showing a preferred circuit configuration of the integrated circuit according to the second embodiment.

In the integrated circuit shown in FIG. 16, areas (protection cell areas) in which protection cells PCs lying within a functional circuit 6 are formed, are disposed at their corresponding ends of sub areas 61 and 62 operated by two source potentials VDD1 and VDD2 within an area (core area) of the functional circuit 6. In FIG. 16, each protection cell PC1 is a cell operated by the source potential VDD1, and each protection cell PC2 is a cell operated by the source potential VDD2. Although an area (electrostatic detection area) containing ESD trigger detection circuits 11 and 12 is formed outside the core area in FIG.16, it may be formed inside the core area.

Laying out the respective protection cells PCs at the ends of the sub areas in the functional circuit 6 in this way makes it possible to bring the sum of a current path between a VDD1 terminal and a GND terminal and a current path between a VDD2 terminal and a GND terminal to the minimum. Thus, since the impedance of a path along which a surge current at the occurrence of an ESD event flows can be reduced as small as possible, ESD resistance of the integrated circuit can further be enhanced as compared with the case in which the protection cells are disposed within the core area at random.

Although the embodiments of the present invention have been described in detail above, the specific configuration and system are not limited to those employed in the present embodiment. A design change of the scope that does not depart from the gist of the present invention, adaptation to other systems, and the like are contained therein.

Although the second embodiment has explained the semiconductor integrated circuit operated by the two power supplies, for instance, it is apparent that a person skilled in the art in the technical field can make an easy extension to a semiconductor integrated circuit operated by three or more power supplies, based on the descriptions of the above respective embodiments.

What is claimed is:

1. A semiconductor integrated circuit comprising:
input/output terminals;
a cell-based functional circuit operated with being connected to a reference potential and one or a plurality of source potentials;
an electrostatic detection unit which detects application of an electrostatic discharge to the corresponding input/output terminal; and
a plurality of protection cells provided corresponding to the respective source potentials within the functional circuit and for protecting the functional circuit from the electrostatic discharge, said protection cells including transistors each connected between the reference potential and the corresponding source potential,
wherein a wiring layer for connecting the protection cells and the electrostatic detection unit and bringing the transistors of the protection cells into conduction in response to the detection of the electrostatic discharge by the electrostatic detection unit is formed.

2. A semiconductor integrated circuit comprising:
a core area formed with a cell-based functional circuit operated with being connected to a reference potential and one or a plurality of source potentials;
a ring-shaped ground wiring disposed around the core area and connected to the reference potential;
one or a plurality of power wirings each shaped in the form of a ring, which are sequentially disposed toward the outside of the core area around the ground wiring and connected corresponding to the one or plural source potentials;
input/output terminals disposed outside the one or plural source potentials;
an electrostatic detection area connected between the ground wiring and the respective power wirings inside or outside the functional circuit and formed with one or a plurality of electrostatic detection units for detecting an electrostatic discharge with respect to the corresponding input/output terminal; and
a protection cell area formed with a plurality of protection cells provided corresponding to the power wirings within the functional circuit and for protecting the functional circuit from the electrostatic discharge, said protection cells including transistors each connected between the ground wiring and the corresponding power wiring,
wherein a wiring layer for connecting the protection cells and the corresponding electrostatic detection unit and bringing the transistors of the protection cells into conduction in response to the detection of the electrostatic discharge by the electrostatic detection unit is formed.

3. The semiconductor integrated circuit according to claim 2, wherein the core area has one or a plurality of sub areas every source potential at which the functional circuit is operated, and the protection cells are disposed at ends of the sub areas each operated at the same source potential as the corresponding power wiring.

4. The semiconductor integrated circuit according to any of claims 1 to 3, wherein the protection cells include NMOS transistors.

5. The semiconductor integrated circuit according to claim 4, wherein each of the protection cells further includes a logic circuit for inverting a signal outputted from the electrostatic detection unit.
